(19) United States
(12) Patent Application Publication
(10) Pub. No.: US 2005/0057928 A1
(43) Pub. Date: Mar. 17, 2005

(54) Illumination kit for flying disc toy

(76) Inventor: Dennis O. Donnelly, Pocatello, ID (US)

Correspondence Address: Dennis O. Donnelly, 56 Tulane Avenue, Pocatello, ID, 83201, US

(21) Appl. No.: 10/663,180

(22) Filed: Sep. 15, 2003

(51) Int. Cl. F21V 1/00

(52) U.S. Cl. 362/240

(57) ABSTRACT

A LED lighting kit for a flying disc toy uses simplified design for ruggedness, light weight, and low cost. The lighting circuit of the kit is separately detachable, permitting easy color changes and user repairs.

### CROSS REFERENCE TO RELATED APPLICATIONS

Not Applicable

### STATEMENT REGARDING FEDERALLY FUNDED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

The current invention relates to flying disc sport and exercise devices, and to lighting equipment for these devices.

Early lighting kits for flying disc toys, as disclosed in U.S. Pat. No. 4,255,895 issued Mar. 17, 1981 to La Brecque, used incandescent bulbs with the disadvantages of high current consumption, short battery life, and requiring multiple batteries for power. The La Brecque design has the further disadvantage of extending more than half the diameter of the disc, partially obstructing the area near the rim required for safe catching of the toy.

An early LED-based lighting kit, disclosed in U.S. Pat. No. 4,431,196 issued Feb. 14, 1984 to Kutnyak, positions LEDs near the rim of the toy. This has the disadvantage of requiring LEDs, wiring, and wiring enclosures in an area where the user must grip the toy. The Kutnyak patent has the further disadvantage that the LEDs themselves must be specially shaped for user safety when catching, to minimize this hazard. The Kutnyak patent fails to include a current limiting component such as a resistor. This omission has the disadvantage of uncontrolled current, leading to short battery life and premature LED burnout.

Many LED lighting systems for flying discs, as disclosed in U.S. Pat. No. 4,307,538 issued Dec. 29, 1981 to Moffitt, require intermittent operation, or flashing, of the lights to permit brighter LED operation and reduce battery drain. Flashing lights have the disadvantage of being visually confusing in high speed motion. Flashing lights have the further disadvantage of requiring a circuit board for control, and an enclosure for the circuit board, which increase weight and cost of the lighting system.

Other LED lighting systems for flying disc toys such as U.S. Pat. No. 5,032,098 issued Jul. 16, 1991 to Balogh, require specialty molding of the disc and/or rim to accommodate lighting components. A lighted flying disc toy currently available from orbydisc.com also requires a specially constructed disc. A requirement for specialty construction has the disadvantages of restricting sources of supply for discs and increasing the cost of each disc. These designs also require structures such as wiring channels or light tubes to cross the area near the rim of the disc, which needs to remain unobstructed for easy catching and throwing of the toy.

Still other lighting systems for flying discs, as disclosed in U.S. Pat. No. 5,536,195 issued Jul. 16, 1996 to Stamos, requires chemoluminescent lighting elements. Chemoluminescent lighting has disadvantages of ghostly coloring, of non-reusable operation, and of requiring specially molded discs.

### BRIEF SUMMARY OF THE INVENTION

A kit adds bright LED lights to a flying disc toy, enabling use of the toy during twilight or at night. The kit uses extreme simplicity to achieve ruggedness and light weight. The kit mounts at the center of the underside of the disc. The kit illuminates the disc and the rim from the center with radial beams of light, showing the spin of the toy's motion when thrown. The kit is compact, leaving the region of the rim unobstructed to permit safe catching and throwing of the disc.

The kit uses LEDs which are small and lightweight, and also a resistor to control current, giving long battery life. The LEDs are constantly on, avoiding visual confusion and circuits for flashing. By using transparent tape to attach the electrical circuit to the disc, the kit avoids a separate support structure and enclosure for the lighting circuit. Tape attachment of the circuit also enables simple color change and repair. The kit may attach to any flying disc, or indeed to any object, thus overcoming the cost and availability disadvantages of specialty disc requirements.

The current invention utilizes today's brightly colored LEDs to overcome the disadvantage of ghostly illumination in chemoluminescent light sources.

The power source is typically a nine volt battery, providing many hours of usable life, and a rechargeable option. The invention discloses a specialized battery holder design for the kit; an alternate design is also disclosed using a commonly available battery holder.

### BRIEF DESCRIPTION OF THE SEVERAL VIEWS OF THE DRAWING

FIG. 1 shows an implementation of the lighting circuit for the kit.

FIG. 2 shows a specialized battery holder design for the kit.

FIG. 3 shows the lighting circuit and battery holder attached to a flying disc toy.

FIG. 4 shows an alternative implementation of the kit, using a commonly available battery holder.

### DETAILED DESCRIPTION OF THE INVENTION

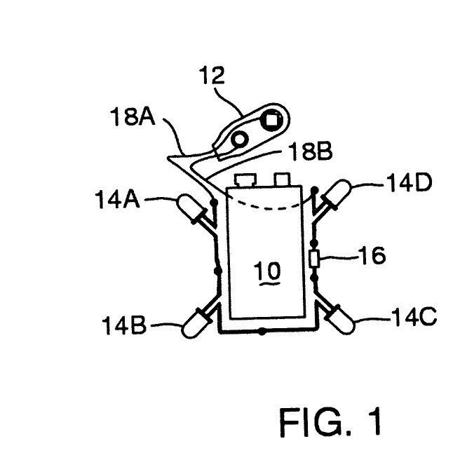

In FIG. 1, a conventional nine volt battery 10 is the power source. A clip-on connector or battery snap 12, shown disconnected in FIG. 1, may make electrical connections to the battery contacts. LEDs 14A-14D, and a current limiting component 16 such as a resistor, form a series circuit closely encircling the battery outline, with sufficient clearance between the circuit and the battery for a battery holder (not shown). The series circuit couples from the positive wire 18A to the negative wire 18B of the battery snap. The battery snap serves as a robust on/off switch. When the battery snap is connected to the battery, the LEDs turn on to provide illumination.

Current limiting component 16 protects the LEDs from premature burnout and extends battery life by limiting battery discharge rate. A worker of ordinary skill in the art may readily determine polarity of required connections, and the resistance value required in the current limiting device for each type of LED. The best mode of making the connections uses wire wrap. Solder joints are an alternative mode. Wire wrap provides flexible interconnect, and avoids a toxic component, lead, usually contained in solder.

In FIG. 1, the current limiting component 16 may occupy any position in the serial chain relative to the other components, while performing its function. Also, the battery snap 12 may occupy any relative position in the serial chain while performing its function.

By using an absolute minimum number of elements, the kit is small, lightweight and low in cost, overcoming disadvantages of excess weight, size, cost, and complexity in older lighting systems for flying disc toys. The current invention omits all the following elements of U.S. Pat. No. 4,431,196 issued Feb. 14, 1984 to Kutnyak:
the transparent membrane
the conductive strips attached to the membrane
the on/off switch
the layer of double-faced adhesive tape
the segmented liner
the liner strips with hole pattern
the hole punches
the need to mount the LEDs in holes
the need for specially shaped LEDs.

Present generation LEDs can provide high brightness without the need for intermittent operation. The current invention makes use of this feature of present generation LEDs to omit the weight and cost of a circuit board required for flashing controls, and of an enclosure for the circuit board, as found in old LED lighting designs. High-brightness LEDs also permit the current invention to omit obstructions near the rim, such as lighting components, wiring channels, and light tubes, required in older systems.

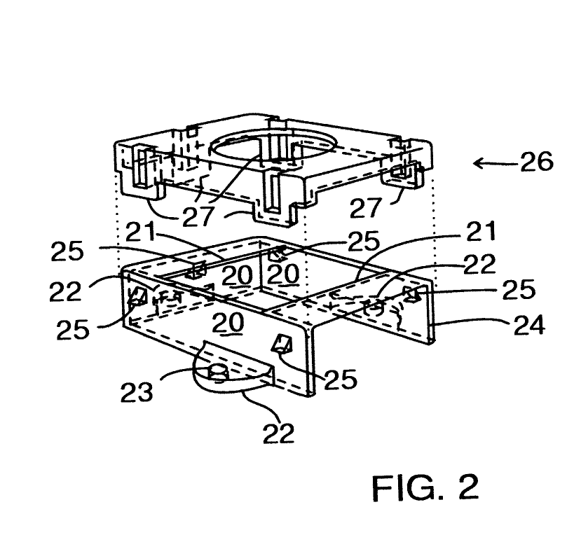

FIG. 2 shows a battery holder design for the kit. The battery holder attaches a nine volt battery to a flat or gently rounded surface, such as a flying disc toy. The battery holder orients the largest face of the battery parallel to the surface, minimizing height above the surface, wind resistance in flight, and twisting forces upon impact. Walls 20, ceiling elements 21, cap 26, and the surface (not shown) provide physical restraint on all sides of the battery when the battery holder is attached to the surface. Flanges 22 have mounting holes 23 for appropriate fasteners, such as rivets, to secure the battery holder to the surface. The flanges and mounting holes are outside the outline of the battery, so that the fasteners do not themselves require any space between the battery and the surface. The best mode of making the battery holder is by plastic injection molding.

The battery holder of FIG. 2 has one open end 24 to permit insertion and removal of the battery, and to provide clearance around the battery terminals for a battery snap. Detents 25 on the walls hold cap 26 via matching ears 27 on the cap. The cap restrains the battery within the open end of the holder, and may also tie down the battery snap wires. Upper edges of the cap are rounded to minimize danger from incidental contact.

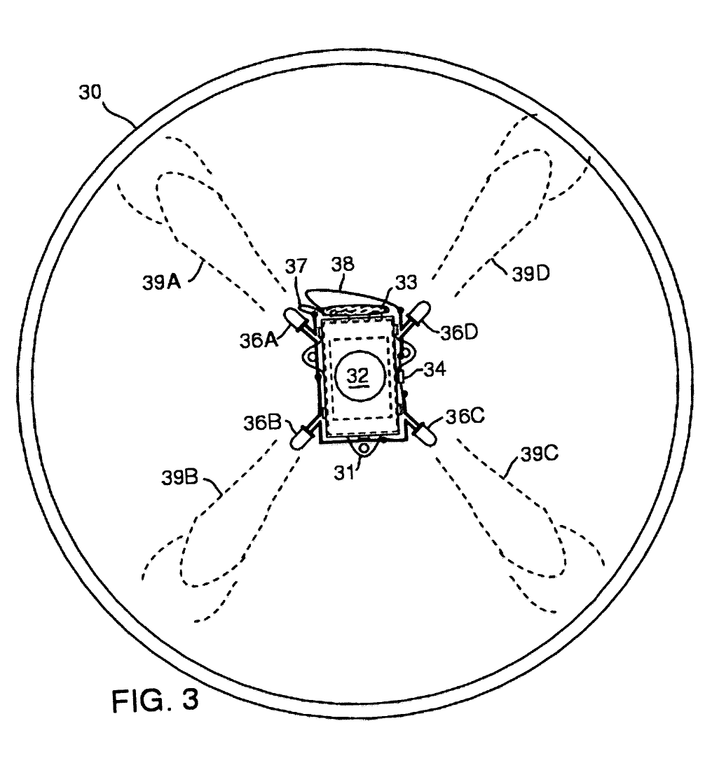

FIG. 3 shows the preferred embodiment of the lighting kit, mounted on the lower surface of a flying disc toy 30, with the battery holder of FIG. 2. The lower surface of the disc faces the point of view. In FIG. 3, battery holder 31 holds a nine volt battery 32 at the center of the surface. A battery snap 33 connects to the battery terminals. The positive wire 37 of the battery snap connects to a series circuit comprising LEDs 36A-36D and current limiting resistor 34, and thence to the negative wire of the battery clip 38. Narrow beams of light 39A-39D from each LED illuminate the surface and the rim of the disc.

Both battery snap wires have length providing slack for strain relief. The series circuit closely surrounds the battery holder to minimize weight and exposure to physical damage during use. Short lengths of clear packaging tape, not shown, attach the resistor, the LEDs, and their interconnecting wires to the underlying surface of the flying disc toy. The tape should avoid covering the light-emitting tip of each LED. The underlying surface replaces a circuit board normally used in commercial electronic devices, and the packaging tape replaces a conventional enclosure for the circuit.

In FIG. 3, the battery snap serves as a rugged on/off switch for the lights. The LEDs turn off when the user removes the battery snap from the battery. This circuit has advantages of lower cost, less weight, and better reliability compared to old designs requiring a separate switch.

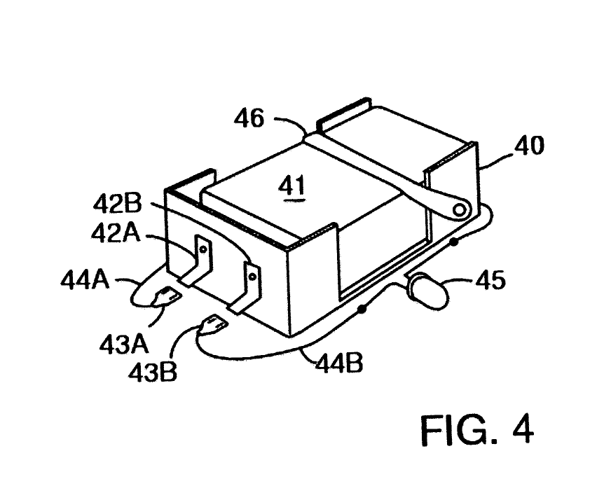

FIG. 4 shows an alternative implementation of the current invention. This implementation uses a commonly available battery holder 40, such as Keystone Electronics #1295. A battery 41 has its terminals coupled to lugs 42A and 42B. Spade clip contacts 43A, 43B may couple to the lugs to connect and disconnect the lighting circuit. FIG. 4 shows only part of the lighting circuit, comprising connector wires 44A and 44B, and light emitting diode 45. The series electrical circuit of FIG. 4 is essentially the same as in FIG. 3. For brevity, the circuit description is not repeated here.

Mounting holes, not shown, in the floor of the holder accept appropriate fasteners such as rivets, to attach the battery holder to an underlying surface such as a flying disc toy. A ceiling element 46, or tie down, couples mechanically across the battery and attaches to the frame of the battery holder, to restrain the battery within the holder.

The current invention replaces the incandescent bulbs of early illumination kits for flying disc toys, and the older LED designs, with modern LEDs providing bright illumination with much lower current requirements than incandescent bulbs. Furthermore, the LED lamps in the current invention are positioned closer to the center of the disc than in old designs, removing the lighting system from the region of the rim.

The current invention utilizes the low current requirements of LEDs to avoid the need for intermittent operation of the lamps as required by old lighting systems. Thus a flying disc toy using the current invention avoids the disadvantage of visual confusion due to flashing. The current invention also avoids the weight, cost, and size disadvantages of circuitry required to operate the LEDs in flashing mode.

By supplying a kit which may be added to any existing disc, the current invention removes the requirement of special structures molded into the disc toy as required by old lighting systems. This overcomes the disadvantages, caused by the specialty structures, of excessive cost and of limited sources of supply.

The making of the current invention requires:
(i) assembling the circuit structure such as shown in FIG. 1, preferably by using wire wrap technology for the connections, using high brightness LEDs, and shaping the circuit to closely encircle a holder for an appropriate battery;
(ii) providing a battery holder such as shown in FIG. 2 or in FIG. 4;
(iii) providing a way of attaching the battery holder to a disc toy, typically using ‘speedy rivets’ for battery holder attachment; and a way of attaching the circuitry to the disc toy such as appropriate lengths of clear packaging tape.

Using the current invention requires:
(i) Mounting the kit to a flying disc toy or other object desired for illumination;
(ii) Installing and connecting an appropriate battery.

1. An illumination device, comprising:
(a) a lighting circuit, comprising a plurality of light emitting diodes and a current limiting device such as a resistor, electrically connected in series between a positive wire of a battery connector and a negative wire of the battery connector,
(b) the battery connector, for connecting the lighting circuit to a battery and for disconnecting the lighting circuit from the battery, the battery having a positive terminal and a negative terminal, the battery connector comprising the positive wire and the negative wire and means for electrically coupling the wires to their respective battery terminals, the positive wire being electrically coupled to the positive battery terminal and the negative wire being electrically coupled to the negative battery terminal when the battery connector is connected to the battery, at least one of the connector wires being electrically decoupled from its battery terminal when the battery connector is disconnected from the battery,
thereby providing a practical lighting unit with minimized number of components and cost.

2. The illumination device of claim 1, further including:
a battery holder, for affixing the battery on a surface which is approximately planar, the battery holder having a plurality of walls parallel to and closely fitting a plurality of sides of the battery which are perpendicular to the surface when the battery holder holds the battery with its largest face adjacent to the surface, the battery holder having means for attaching the battery holder firmly to the surface, the battery holder having at least one ceiling element for restraining the battery between the battery holder and the surface.

3. The illumination device and battery holder of claim 2, in which:
the battery holder attaches to the approximate center of a lower surface of a flying disc toy having a rim protruding toward the lower surface,
the illumination device attaches to the lower surface approximately adjacent to, and approximately encircling, the battery holder, and
the light emitting diodes point in a direction such that when the lighting circuit is connected to the battery, a beam of light from each light emitting diode points across the surface toward the rim, thereby illuminating the surface and the rim.

4. The flying disc toy, battery holder, and illumination device of claim 3, in which:
the illumination device is detachable from the flying disc toy and battery holder, and a replacement illumination device may readily attach to the flying disc toy and battery holder, thereby enabling simple color changes and user repairs of the illumination device alone.

5. The illumination device and battery holder of claim 2, in which:
the illumination device and battery holder may attach to an arbitrary object for illuminating the object at night.

6. The illumination device and battery holder of claim 5, in which:
the illumination device is detachable from the battery holder and from the object, and a replacement illumination device may readily attach to the battery holder and the object, thereby enabling simple color changes and user repairs of the illumination device alone.

7. An illuminated flying disc toy, comprising:
(a) a lightweight circular disc, the disc having an upper surface and a lower surface when the disc is horizontal, the disc having an outer edge with a rim, the rim protruding in the direction of the lower surface, and
(b) a separately constructed illumination kit, firmly attached to the lower surface, approximately at the center of the lower surface, comprising:
(i) a battery holder, for retaining a battery having a positive terminal and a negative terminal, the battery holder having means for firmly attaching the battery holder to the surface, the battery holder having means including a plurality of walls approximately perpendicular to the surface and at least one ceiling element approximately parallel to the surface, for restraining the battery within the battery holder;
(ii) means including a rugged connector for connecting a lighting circuit to the battery terminals and for disconnecting the lighting circuit from the battery terminals;
(iii) the lighting circuit, comprising a plurality of LEDs and a current limiting device such as a resistor, the lighting circuit elements being connected electrically in series and disposed approximately adjacent to the battery holder on the lower surface, the lighting circuit and the connector forming a continuous, electrically conducting path between the positive terminal and the negative terminal when the connector is connected to the battery terminals, and when the connector is disconnected from the battery terminals the lighting circuit and the connector do not form a continuous, electrically conducting path between the battery terminals.

8. The illuminated flying disc toy of claim 7, in which:
each of the LED lamps creates a fairly narrow beam of light, and
the light beam of each LED lamp points across the lower surface of the flying disc toy toward the rim, thereby illuminating the lower surface and the rim.

9. The illuminated flying disc toy of claim 7, in which:
the illumination kit occupies a space near the center of the disc extending not more than half the radial distance from the center to the rim, thereby leaving unobstructed an area nearest the rim extending at least half the radial distance from the rim to the center of the disc.

10. The illuminated flying disc toy of claim 7, in which:
the lighting circuit and connector of the kit are detachable from the flying disc toy and the battery holder, and a replacement lighting circuit and connector may readily attach to the flying disc toy and the battery holder, thereby enabling simple color changes and user repairs of the illumination kit.

11. A battery holder for affixing a battery to a surface, the battery having a positive contact and a negative contact, comprising:
(a) means including a plurality of walls parallel to and closely encircling the sides of the battery which form the largest outline of the battery, the walls being approximately perpendicular to the surface, at least one ceiling element approximately parallel to the surface which joins the distal ends of the walls farthest from the surface, and a cap, for retaining the battery within a pocket formed by the walls, the ceiling element, the surface, and the cap when the battery holder is attached to the surface; the walls having an open end enabling insertion and removal of the battery, the open end of the walls providing access to both of the battery contacts for a battery connector; the walls having a plurality of detents for mating to and retaining the cap; the cap, when attached to the detents of the walls with the battery inserted, partially enclosing the open end of the walls and retaining the battery within the pocket, and
(b) means for attaching the battery holder to the surface.
